(19) United States
(12) Patent Application Publication
(10) Pub. No.: US 2019/0325470 A1
(43) Pub. Date: Oct. 24, 2019

(54) SWAG WEIGHTED INVENTORY FAST TRACKER

(71) Applicant: Capital One Services, LLC, McLean, VA (US)

(72) Inventor: Ian Camacho, Los Angeles, CA (US)

(73) Assignee: Capital One Services, LLC, McLean, VA (US)

(21) Appl. No.: 15/960,858

(22) Filed: Apr. 24, 2018

(51) Int. Cl. G06Q 30/02; G06Q 10/08; G06F 21/32

(52) U.S. Cl. CPC G06Q 30/0223; G06Q 30/0211; G06F 17/30879; G06F 21/32; G06Q 10/087

(57) ABSTRACT

A computer-implemented method of promotional item inventory management is described. An access control module may receive a credential from a user. A processor circuit may verify a validity of the credential of the user and retrieve an activity log associated with the user from a server. The processor circuit may retrieve a current stock level record from a memory and provide an item recommendation to the user based on the user's activity log, the current stock level record, and a popularity factor. The processor circuit may receive a response to the item recommendation from the user; and grant the user an access privilege to one item based on the received response. The processor circuit may provide system administrators and item managers more accurate information and data used to track return on investment.

### FIELD

The present disclosure generally relates to inventory management of promotional items.

### BACKGROUND

It is a common practice that enterprises offer gifts or free items (or “swag”) to potential customers for promotional purposes. For example, the promotional items can include shopping totes, notebooks, notepads, pens, water bottles, mugs, stress balls, jump ropes, sunglasses, umbrellas, USB car chargers, USB flash drives, etc. A traditional way to manage the inventory may involve a designated person checking the stock level on a periodic basis (e.g., daily or weekly) and manually placing orders for replenishment. If the tasks of stock monitoring and ordering are assigned to different departments or different staff members, the whole process may be time-consuming and require back and forth communications. For example, a local branch of a national financial institution may store various gifts and free items at the branch. But if the stock level of one item is low, a staff member at the branch may have to submit an order request to another department or division within the institution, most likely a regional headquarter or even the national headquarter. The whole process can take a long time and a lot of resources to complete. Additionally, multiple inaccuracies can occur, in terms of item type, counts and orders. Furthermore, there is no way to track rate of distribution or reason for use. This lack of information makes it difficult to track theft, errors by vendors, return on investment, etc.

During the distribution process, human biases may lead to a person favoring one item over another item, causing uneven distribution of the items. The financial institution may also have incentive to maximize its return on investment by identifying the best promotional item to distribute under certain circumstances.

### SUMMARY

The present disclosure describes a system and method of managing an inventory of promotional items. According to one aspect of the present disclosure, the method may include: receiving, by a processor, a user credential from a user; receiving a reason for use from the user; receiving an account type from the user; sending the user credential, the reason for use, and the account type to a server; receiving an item recommendation from the server; outputting the item recommendation to the user; receiving a response to the item recommendation from the user; and granting the user an access privilege based on the received response.

In some embodiments, the method may include receiving information of an identification card from an access control module, wherein the access control module may include one of a magnetic stripe card reader, a contactless card reader, or a chip card reader. In some embodiments, the method may include receiving a fingerprint from an access control module. In some embodiments, the reason for use may include one of promotional event, account opening, customer request, or complaint handling. In some embodiments, the account type may include one of checking account, saving account, credit card account, money market account, certificate of deposit account, automobile loan account, or mortgage account.

In some embodiments, the method may include updating an item count; and sending the updated item count to the server. In some embodiments, the method may include detecting, by a weight sensing module, a total item weight; and updating, by the processor, the item count based on the new total item weight and an unit item weight.

In another aspect, the present disclosure describes a computer-implemented method for generating a promotional item recommendation. The method may include: receiving, by a server, a user credential associated with a user from a user device; retrieving an activity log associated with the user based on the received user credential; receiving a reason for use and an account type; retrieving return on investment (ROI) data associated with one or more promotional items; checking availability of the one or more promotional items; generating an item recommendation based on the activity log, the reason for user, the account type, the ROI data, and the availability of the one or more promotional items; and outputting the item recommendation to the user device.

In some embodiments, the user credential may include information of an identification card, a personal identification number, biometric information of the user, or a combination thereof. In some embodiments, the activity log may include one or more item names and one or more quantities associated with the one or more item names. In some embodiments, the reason for use may include one of promotional event, account opening, customer request, or complaint handling. In some embodiments, the account type may include one of checking account, saving account, credit card account, money market account, certificate of deposit account, automobile loan account, or mortgage account. In some embodiments, the method may include receiving weather information from an external source; and generating the item recommendation based on the received weather information. In some embodiments, the method may include receiving, for each of the one or more promotional items, information selected from the group consisting of popularity per time of day, popularity per day of week, popularity per quarter of year, popularity per season, popularity per geographic location, popularity per weather condition, and a combination thereof, wherein popularity comprises rate of distribution; and generating the item recommendation based on the received information.

In another aspect, the present disclosure describes a system of promotional item inventory management. The system may include a memory; a scanner configured to read a UPC barcode or QR code; a weight sensing module configured to detect a total item weight; and a processor in communication with the scanner and the weight sensing module and configured to execute program instructions causing the processor to: receive the UPC barcode or QR code from the scanner; retrieve an item name associated with the UPC barcode or QR code from the memory; receive the total item weight from the weight sensing module; retrieve a unit item weight associated with the item name from the memory; determine an item count based on the total item weight and the unit item weight; and output the item name and the item count to a server.

In some embodiments, the processor may compare the item count to a threshold value; generate an order in response to the item count being less than the threshold value; and output the order to a pre-determined entity. In some embodiments, the processor may receive a user credential from a user; receive a reason for use from the user; receive an account type from the user; send the user credential, the reason for use, and the account type to a server; receive an item recommendation from the server; output the item recommendation to the user; receive a response to the item recommendation from the user; and grant the user an access privilege based on the received response.

### BRIEF DESCRIPTION OF THE DRAWINGS

To assist those of skill in the art, reference is made to the accompanying figures. The accompanying figures, which are incorporated in and constitute a part of this specification, illustrate one or more embodiments of the invention and, together with the description, help to explain the invention. Illustrative embodiments are shown by way of example in the accompanying drawings and should not be considered as limiting.

FIG. 1 is a block diagram showing different modules within one unit of an inventory management system, according to some embodiments of the present disclosure.

FIG. 2 is a flowchart showing a method of adding a new item to the inventory management system, according to some embodiments of the present disclosure.

FIG. 3 is a flowchart showing a method of accessing a promotional item in the inventory management system, according to some embodiments of the present disclosure.

FIG. 4 is a flowchart showing a method of providing an item recommendation, according to some embodiments of the present disclosure.

FIG. 5 is a block diagram showing various components within a computer in the inventory management system, according to some embodiments of the present disclosure.

### DETAILED DESCRIPTION

The present disclosure describes systems and methods of managing an inventory of promotional items. In some embodiments, the system may be configured to determine an item count based on a total item weight. In some embodiments, the system may be configured to grant a user access to a promotional item only if the user's credential is verified. In some embodiments, the system may be configured to collect a reason for use for a promotional item and provide an item recommendation to a user.

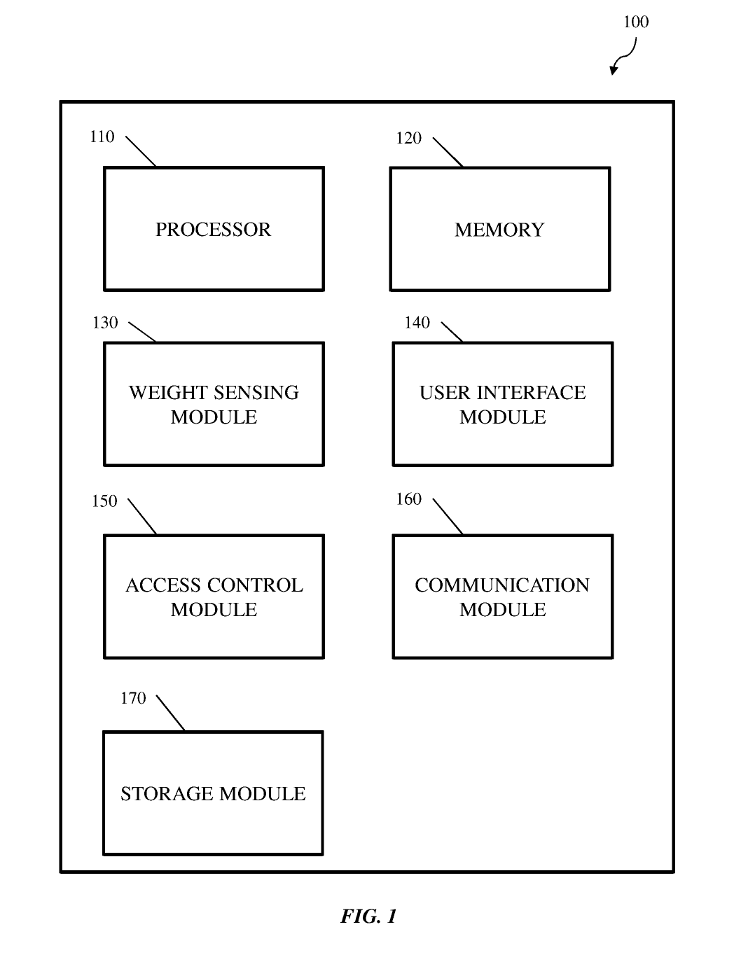

FIG. 1 is a block diagram showing a system 100 of promotional items inventory management, according to some embodiments of the present disclosure. The system 100 (or “user device”) may include a processor 110, a memory 120, a weight sensing module 130, a user interface module 140, an access control module 150, a communication module 160, and a storage module 170.

The system 100 may include a configurable and/or programmable processor 110 and, optionally, additional configurable and/or programmable processor(s) 110 (for example, in the case of systems having multiple processors), for executing computer-readable and computer-executable instructions or software stored in memory 120 and other programs for controlling system hardware. In some embodiments, processor 110 may include a general purpose computer processor. In some embodiments, processor 110 may include a low-power processor designed for mobile application. In some embodiments, processor 110 may include other types of processors, or a combination thereof.

Memory 120 may include a computer system memory or random access memory, such as DRAM, SRAM, EDO RAM, and the like. Memory 120 may include other types of memory as well, or combinations thereof. In some embodiments, memory 120 may be configured by a system administrator to store data of one or more universal product codes (UPC) or Quick Response codes (QR code). In some embodiments, memory 120 may be configured to store item cost, item weight, item box count, etc., which are associated with one or more UPC or QR codes. In some embodiments, memory 120 may be configured to store popularity of the items as well as rate and speed of distributing the promotional items.

Weight sensing module 130 may be configured to detect a weight of the items stored in storage module 170 of the system. In some embodiments, the weight sensing module 130 may be configured to located inside the storage module 170, such as at the bottom and inside of the walls within a storage bin of the system, or built into the bottom and the walls themselves. In some embodiments, the weight sensing module 130 may include a force sensor which may be configured to sense a gravitational force. In some embodiments, the weight sensing module 130 may be configured to determine a first weight when the storage bin is empty and a second weight when the storage bin is filled with promotional items. The total item weight can be calculated as the difference between the second weight and the first weight.

User interface module 140 may include different forms of user interfaces depending on specific needs of different embodiments. In some embodiments, user interface module 140 may include one or more displays, such as a liquid crystal display (LCD), to show device status and information to a user. For example, the display may be configured to show an item name, stock item image and item count. In some embodiments, user interface module 140 may include one or more touch screens to receive a user's input. In some embodiments, user interface may include one or more buttons to receive a user's input. For example, the user may select a new item using the touch screen or buttons. In some embodiments, user interface module 140 may include a barcode scanner which may be configured to read a barcode on a package or an external surface of a promotional item. In some embodiments, user interface module 140 may include a Quick Response (QR) code scanner which may be configured to read a QR code on a package or an external surface of a promotional item. In some embodiments, the barcode scanner or the QR code scanner may be embedded in the inventory management system. In some embodiments, the barcode scanner or the QR code scanner may be a standalone component which may be configured to communicate with the user interface module 140 via a data cable or wirelessly. In some embodiments, user interface module 140 may be configured to receive an image of a barcode or a QR code captured by a mobile device.

Access control module 150 may be configured to grant or deny a user access to a promotion item. In some embodiments, access control module 150 may be configured to receive a user's credential. For example, access control module 150 may include a personal identification number (PIN) entry device (e.g., a PIN pad), a card reader (e.g., a magnetic stripe card reader, a contactless card reader, a chip card reader, etc.) or a biometric security reader (e.g., a fingerprint reader, a retinal eye scanner, etc.). Access control module 150 may be configured to determine if the user has a privilege of access to the promotional item. In some embodiments, access control module 150 may include a locking mechanism which may grant the user access to an item in response to a valid user credential.

Communication module 160 may be configured to communicate with a server. In some embodiments, communication module 160 may include one or more local area network (LAN) interfaces. In some embodiments, communication module 160 can include one or more wide area network (WAN) interfaces. In some embodiments, communication module 160 may include one or more cellular communication interfaces, such as a 4G Long-Term Evolution (LTE) interface. In some embodiments, communication module 160 may include a Wi-Fi interface configured to connect and communicate with a Wi-Fi network. In some embodiments, communication module 160 may include a Bluetooth® interface. In some embodiments, communication module 160 can include other types of communication components as well, or a combination thereof.

Storage module 170 may be configured to provide storage room for one or more promotional items. In some embodiments, storage module 170 may contain weight sensing module 130 lining the bottom and inside of the walls within a storage bin of the system. In some embodiments, storage module 170 may contain weight sensing module 130 built into the bottom and the walls themselves. In some embodiments, the system may be configured to include multiple storage modules, whereas each storage module may be configured to store one type of promotional item.

In the event of losing a network connection to the system (a Wi-Fi outage, server down, etc.), the user may still be able to manually enter the data to the system and the system may send the data to the server after the connection is restored. In the event of power outage, a backup battery may be used to power the system. The system may operate in a low power mode in which it sends data at the end of the day or the week.

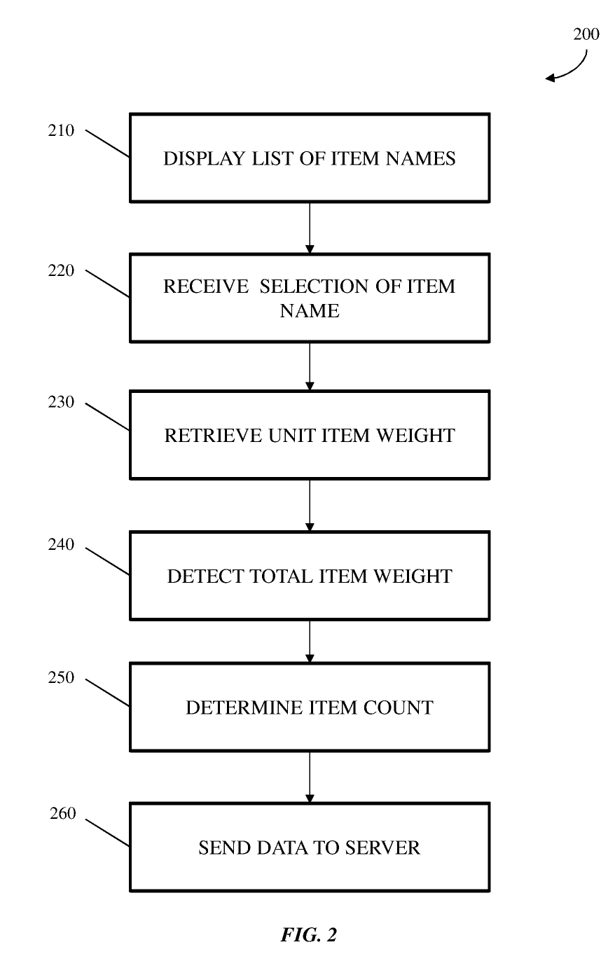

FIG. 2 is a flowchart showing a method 200 of adding a new item to the inventory management system, according to some embodiments of the present disclosure. For example, the user may receive a shipment of a number of USB flash drives and want to place them into the system. In some embodiments, once the user activates the system, the processor 110 may be configured to check if there is any item left in the storage bin. For example, the processor 110 may be configured to display a message in the user interface module 140 asking the user to visually verify the storage bin is empty. In another example, the processor 110 may be configured to receive a weight reading from the weight sensing module 130 and determine if the storage bin is empty.

At step 210, the processor 110 may be configured to display in the user interface module 140 a list of existing item names stored in the memory 120. In some embodiments, the list of existing item names may be entered manually by a system administrator. In some embodiments, attributes associated with the item names may also be entered manually by the system administrator. The attributes may include a stock image, product box count, UPC or QR code, weight per unit item, cost per unit item, etc.

At step 220, the user interface module 140 may be configured to receive a selection of an item name from the user. In some embodiments, the user may use a keyboard or a touch screen to search for and select an item name. The user interface module 140 may display the selected item stock image as one toggles through the available options. In some embodiments, the user may use the barcode scanner to scan an item UPC barcode or QR code, and the processor 110 may then determine an item name and an item count corresponding to the UPC barcode or QR code.

At step 230, the processor 110 may be configured to retrieve a unit item weight associated with the item name from the memory 120. For example, the user may select an item name of “USB flash drive” at step 220, and the processor 110 may retrieve a unit weight of a USB flash drive from the memory 120 previously entered by a system administrator. The processor 110 may be configured to prompt the user to enter one unit of the selected item and compare the stored system weight against the measured weight of the item. If they match, the system continues to step 240. If they do not match, the processor 110 may be configured to prompt the user to clear the item and check to ensure nothing else remains in the bin and is clean.

At step 240, the weight sensing module 130 may be configured to detect a total item weight. In some embodiments, the weight sensing module 130 may be configured to determine a first weight when the storage bin is empty and a second weight when the storage bin is filled with promotional items. The total item weight can be calculated as the difference between the second weight and the first weight.

At step 250, the processor 110 may be configured to calculate an exact item count based on the unit item weight and the total item weight. For example, if the unit item weight of the USB flash drive is 5.0 ounces and the total item weight is 500.0 ounces, the processor 110 may determine a total item count of 100 USB flash drives.

In some embodiments, the system may be configured to provide the user an option to return any unused promotional items. For example, the processor 110 may be configured to display a separate “Return” function on the user interface module 140 for the user to select. Once it is selected, the access control module 150 may be configured to grant the user access to the storage bin for completion of the return.

In some embodiments, the processor 110 may be configured to determine if there is “cross-contamination” in which wrong items are in the bin. For example, if a USB flash drive has a weight of 5.0 ounces, then the only possible weights for this item could end in multiples of 5 (i.e. 5 and 0). Thus, if the system notes a weight ending in an odd number like 13.0 ounces or 5.9, ounces then there is either: A) an error in that one did not zero out the weight properly prior to adding items, or B) a foreign item fell in. The processor 110 may thus prompt the user to check the bin for foreign items and remove them. Once the foreign items are removed, and the total unit weight matches an acceptable unit weight (For example, the corrected weight is now 10.0 ounces, or 2 items) the processor 110 may ask user to confirm that only the correct items remain in the bin. If the user fails to do so, a prompt to clear or check the bin should remain, but the discrepancy will remain in processor 110 and further removal of items will still be reflected deducting unit item weight.

In some embodiments, via the user interface model 140 the user may scan a UPC or QR code on a product box for bulk refills of items. In doing so, the system may automatically add the nominal count into the bin (e.g., 100 USB flash drives in a product box is added to the memory 120 per the scanned box UPC or QR code). In some embodiments, the actual item count based on the total item weight may be compared against a nominal item count associated with the UPC or QR code. If the system consistently finds that the actual count is lower than the nominal count (i.e. they are being shorted by the item vendor that packages the boxes) this will be data to consider in terms of renewing vendor contracts or whether theft occurs between package opening and emptying into bins. The processor may also take into account overages of actual amounts and average these out to determine the margin of error. At this point a system administrator may determine an acceptable margin of error to continue working with the vendor or determine whether theft is occurring from users.

In some embodiments, the processor 110 may be configured to check overflow. In some embodiments, the processor 110 may be configured to calculate a current available volume by subtracting the current item count multiplied by item dimensions from the total volume of the storage bin. The processor 110 may be configured to multiply the incoming item count by item dimensions to determine a total incoming volume. The processor 110 may be configured to compare the current available volume to the total incoming volume and determine an internal overage amount. The user interface module 140 will ask the user for the count of the remaining items in the item box that are not in the bin, to check against vendor error or user theft (without disclosing a discrepancy on the user end). As the bulk item box has been opened and all items accounted for by the system, the user will add any remaining items in the box into the storage module 170 in the future and not re-scan the UPC or QR code to prevent errors in inventory. In some embodiments, the system may be configured to detect overflow or cross-contamination with an infrared camera connected to the system.

In some embodiments, the processor 110 may be configured to ask the user if there is any damaged item. For example, it may prompt the user to report damaged items by showing in the user interface module 140 a message such as “Are any items damaged? Yes/No.” If the user selects “No,” the processor 110 may proceed to step 260. Otherwise, if the user selects “Yes,” then the processor 110 may ask the user to enter the number of damaged items and to remove the damaged items prior to proceeding to step 260.

At step 260, the processor 110 may be configured to send the item name and actual item count to a server. For example, the processor 110 may send the item name of “USB flash drive” and the actual item count of 100 to the server.

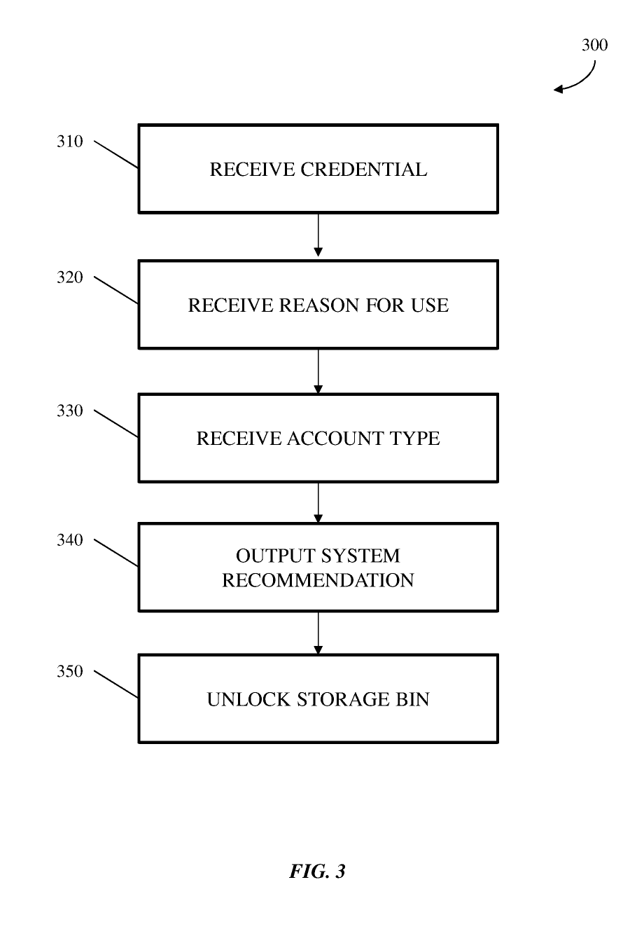

FIG. 3 is a flowchart showing a method 300 of accessing an item in the inventory management system, according to some embodiments of the present disclosure. At step 310, the processor 110 may be configured to receive a user's credential. For example, the user may want to take a number of USB flash drives. Therefore, the user may swipe an employee identification card in a card reader of the access control module 150. In some embodiments, the user may also tap a contactless smart card on a smart card reader, enter a personal identification number into a PIN pad, or use a biometric reader of the access control module 150. In some embodiments, the processor 110 may transmit the card information or biometric data to a server for verification, through the communication module 160. Once the user's credential is verified, the method 300 may proceed to the following steps. In some embodiments, the processor 110 may also be configured to check stock level of the promotional item. If the item is not available, the processor 110 may be configured to output a message to the user on the user interface module 140.

At step 320, the processor 110 may be configured to receive a reason for use from the user. In some embodiments, in a display of the user interface module 140, the system may be configured to show a message such as “Please select a reason for use from the list: i) Promotion Event; ii) New Account Opening; iii) Career Fair; iv) Street Team; iv) Surprise and Delight; v) Customer Request; vi) Handle a Complaint; vii) Remove Items/Swap out; viii) Return Items; and ix) Other.” The user may press a button or use a touch screen to select one of the reasons for use. For example, a user can select “Promotional Event” for a large event coming up which requires large amounts of items, which prevents any backend alerts of unusually high amounts of items being taken out (i.e. theft) and can be compared against upcoming events to validate. In some embodiments, the user must type a specific reason for use with a keyboard or a touch screen under “Other.” In some embodiments, the processor 110 may be configured to send the reason for use to a server.

At step 330, the processor 110 may be configured to receive a selection of an account type. In some embodiments, the system may be configured to show a list of account types in the user interface module 140 for the user to select. In some embodiments, the account types can include checking account, saving account, credit card account, money market account, certificate of deposit account, automobile loan account, mortgage account, etc. The user may press a button or use a touch screen to select one of the account types. In some embodiments, the processor 110 may be configured to send the account type to a server.

At step 340, the processor 110 may be configured to provide an item recommendation to the user. In some embodiments, the processor 110 may be configured to receive an item recommendation from a server and display it in the user interface module 140. In some embodiments, the item recommendation may match the item the user intends to access. In some embodiments, the item recommendation may be different from the intended item. For example, the user would like to take a number of USB flash drives, but the system may be configured to show on the user interface model 140 a screen prompt such as “We noticed that you haven't selected lanyards in a while. Would you like to grab some lanyards?” with an image of lanyards. The user may have the option to override this prompt with a “Yes” or “No” response. If the user accepts the system's recommendation by selecting “Yes,” the processor 110 may be configured to show the user a location of the recommended item. If the user overrides the system's recommendation by selecting “No,” the user may proceed to step 350.

At step 350, the access control module 150 may be configured to grant the user access to the item based on the user's selection. For example, the access control module 150 may be configured to unlock the bin corresponding to the selected item. The user may then take out one or more of the target items. After the operation is completed, the weight sensing module 130 may be configured to detect an updated total item weight and the processor 110 may be configured to calculate a new total item count.

In some embodiments, the processor 110 may be configured to update the item count periodically (e.g., daily). The processor 110 may be configured to compare the item count to a threshold value. If the item count is equal to or less than the threshold value, the processor 110 may be configured to place a new order or ask the user if they want to order (so as to prevent multiple orders of the same item). In some embodiments, the processor 110 may be configured to transmit the new order to a server to process. In some embodiments, the processor 110 may be configured to show the status of the order on the user interface module 140. The status information may include a date when the order is placed, a shipping date, a tracking number, estimated time for arrival, shipping method, etc.

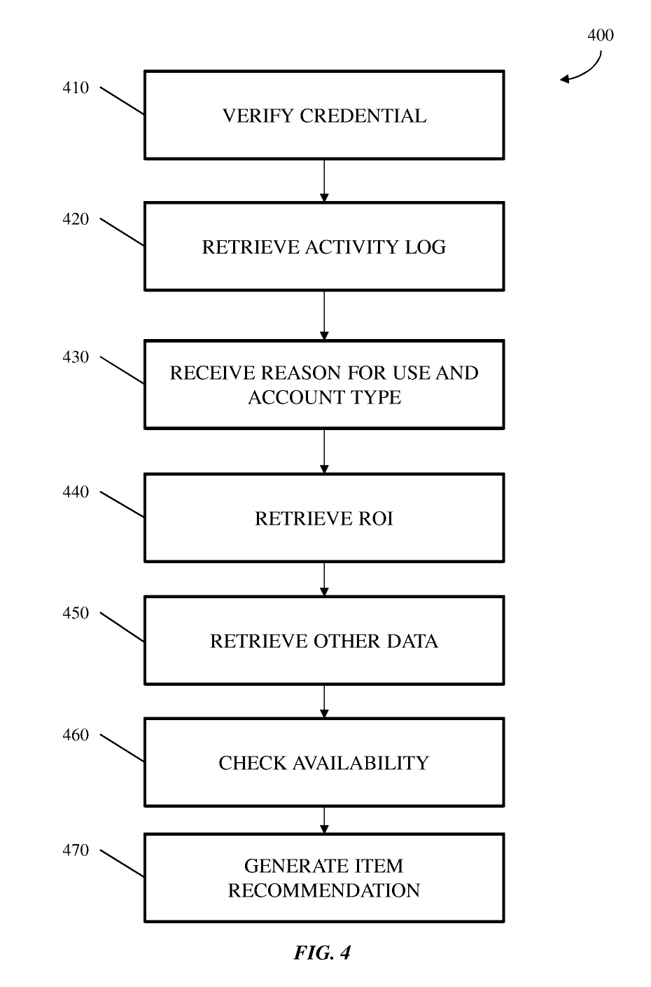

FIG. 4 is a flowchart showing a method 400 of providing an item recommendation with a server, according to some embodiments of the present disclosure. At step 410, a server may be configured to verify a user's credential received from the inventory management system. In some embodiments, the credential may include information associated with an employee identification card, a personal identification number, or biometric information. If the credential is determined to be valid, the method 400 proceeds to step 420.

At step 420, the server may be configured to retrieve an activity log associated with the user. In some embodiments, the activity log may include a historical record of all promotional items the user has taken previously. In some embodiments, the activity log comprises one or more item names and one or more item counts associated with the one or more item names. In some embodiments, the activity log may also include additional information such as when the item was taken, and purpose of use. Human bias and favor tends to result in choosing the same items repeatedly, and the activity log may be used to identify any biases. Therefore, the final item recommendation may ensure a more even distribution of items over time. For example, a user continually pulls USB flash drives but neglects to grab lanyards, the server may be configured to recommend lanyard to the user.

At step 430, the server may be configured to receive a reason for use and an account type from the system. In some embodiments, the reason for use may include promotion event, new account opening, career fair, street team, surprise and delight, customer request, customer complaint, other, etc. In some embodiments, the account types may include checking account, saving account, credit card account, money market account, certificate of deposit account, mortgage account, auto loan account, etc.

At step 440, the server may be configured to retrieve return on investment (ROI) data associated with the promotional items. In some embodiments, the ROI may be defined as a ratio between the net value received and the cost of the promotional item. In some embodiments, the ROI may be calculated as ROI=(V−C)/C, whereas V represents the total value received and C represents the cost of the item. In some embodiments, different account types may have different values for a financial institution. For example, a credit card account may have higher value than a checking account, and therefore, the same promotional item may have a higher ROI for opening a credit card account than opening a checking account.

In some embodiments, the server may be configured to retrieve ROI data associated with other promotional items which are different from the intended item. For example, in addition to ROI of the USB flash drive which the user wants, the server may also retrieve ROI of other items in stock such as sunglasses, stress ball, etc. for further analysis.

At step 450, the server may be configured to retrieve other related data. In some embodiments, the related data may include an account history of a target customer whom the promotional item will be given to, an account balance of the target customer, weather information, etc. In some embodiments, the user may manually enter an account number or an account owner's name, or swipe a credit/debit card (without charging). The system may retrieve an account profile associated with the account number or the owner's name. For example, if the target customer is a long-time customer with the financial institution or has multiple accounts, the server may be configured to determine that this customer is a high value customer and eligible for high value promotional item. Alternatively, a system administrator may look up the account and flag it for high value promotional item. In another example, if the weather forecast suggests there is a high probability of rain, the server may be configured to determine that an umbrella or a raincoat would be a proper promotional item.

At step 460, the server may be configured to check stock level of the promotional items to determine which items are available to distribute. Any item that is currently out of stock should not be recommended to the user.

At step 470, the server may be configured to generate an item recommendation and send to the inventory management system. In some embodiments, the server may be configured to identify a best fit item based on factors including the user's activity log, ROI of items, reason for use, account type, customer profile/account history, weather, item availability, etc. In some embodiments, different factors may account for different weight during the decision process and a system administrator may set and adjust the weight accordingly. For example, if the goal is to minimize cost, then ROI data may become the dominate factor. If the goal is to ensure an even distribution of items, the user's activity log may carry the most weight. If the goal is to enhance customer satisfaction and reward loyal customers, the customer profile/account history may be the most important factor.

In some embodiments, the system may track various data: rates and speed of distribution, popularity of items per market/region/location, popularity of items per specific times. In some embodiments, the system may track rates and speed of distribution based on time of the day, day of the week, or seasons/quarters. In some embodiments, the system may track the overall rate when items are going the most and the speed at which items are going the most at certain times. In some embodiments, the system may determine popularity of items based on geographic locations. For example, USB flash drives may be the favorite swag item in Branch A of the financial institution, while Branch B may prefer sunglasses. In some embodiments, the system may determine popularity of items based on time. For example, free coffee may be the best swag item in the morning, while stress balls may be the most popular item in the afternoon. In some embodiments, the system may generate an item recommendation based on the popularity of the items, for example by using any of the popularity factors mentioned above.

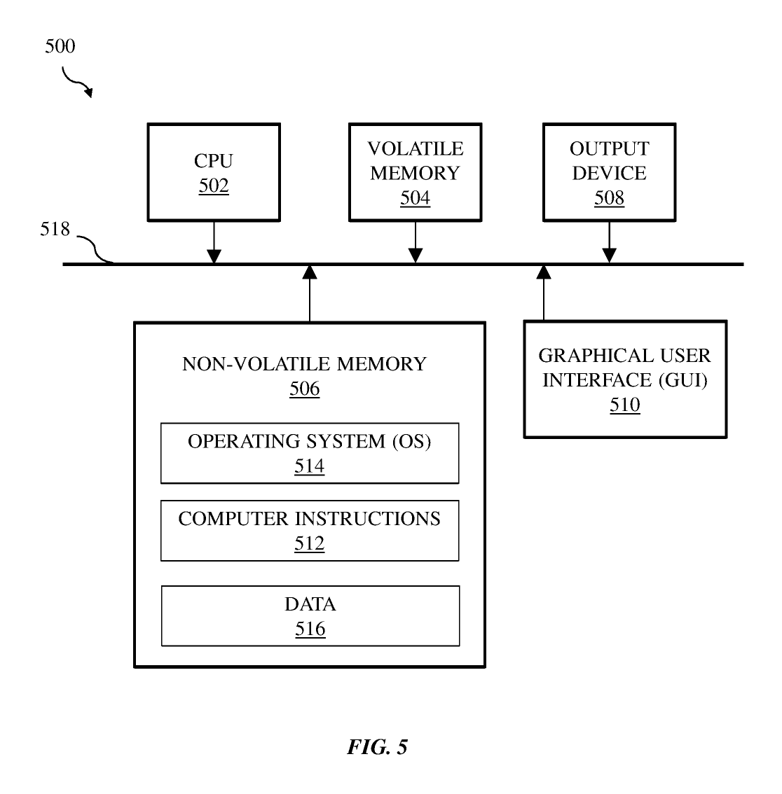

FIG. 5 shows an illustrative computer 500 that can perform at least part of the processing described herein, according to an embodiment of the disclosure. The computer 500 may include a processor 502, a volatile memory 504, a non-volatile memory 506 (e.g., hard disk), an output device 508 and a graphical user interface (GUI) 510 (e.g., a mouse, a keyboard, a display, for example), each of which is coupled together by a bus 518. The non-volatile memory 506 may be configured to store computer instructions 512, an operating system 514, and data 516. In one example, the computer instructions 512 are executed by the processor 502 out of volatile memory 504. In some embodiments, the computer 500 corresponds to a virtual machine. In other embodiments, the computer 500 corresponds to a physical computer.

Referring again to FIG. 5, processing may be implemented in hardware, software, or a combination of the two. In various embodiments, processing is provided by computer programs executing on programmable computers/machines that each includes a processor, a storage medium or other article of manufacture that is readable by the processor (including volatile and non-volatile memory and/or storage elements), at least one input device, and one or more output devices. Program code may be applied to data entered using an input device to perform processing and to generate output information.

The system can perform processing, at least in part, via a computer program product, (e.g., in a machine-readable storage device), for execution by, or to control the operation of, data processing apparatus (e.g., a programmable processor, a computer, or multiple computers). Each such program may be implemented in a high level procedural or object-oriented programming language to communicate with a computer system. However, the programs may be implemented in assembly or machine language. The language may be a compiled or an interpreted language and it may be deployed in any form, including as a stand-alone program or as a module, component, subroutine, or other unit suitable for use in a computing environment. A computer program may be deployed to be executed on one computer or on multiple computers at one site or distributed across multiple sites and interconnected by a communication network. A computer program may be stored on a storage medium or device (e.g., CD-ROM, hard disk, or magnetic diskette) that is readable by a general or special purpose programmable computer for configuring and operating the computer when the storage medium or device is read by the computer. Processing may also be implemented as a machine-readable storage medium, configured with a computer program, where upon execution, instructions in the computer program cause the computer to operate. The program logic may be run on a physical or virtual processor. The program logic may be run across one or more physical or virtual processors.

Processing may be performed by one or more programmable processors executing one or more computer programs to perform the functions of the system. All or part of the system may be implemented as special purpose logic circuitry (e.g., an FPGA (field programmable gate array) and/or an ASIC (application-specific integrated circuit)).

Additionally, the software included as part of the concepts, structures, and techniques sought to be protected herein may be embodied in a computer program product that includes a computer-readable storage medium. For example, such a computer-readable storage medium can include a computer-readable memory device, such as a hard drive device, a CD-ROM, a DVD-ROM, or a computer diskette, having computer-readable program code segments stored thereon. In contrast, a computer-readable transmission medium can include a communications link, either optical, wired, or wireless, having program code segments carried thereon as digital or analog signals. A non-transitory machine-readable medium may include but is not limited to a hard drive, compact disc, flash memory, non-volatile memory, volatile memory, magnetic diskette and so forth but does not include a transitory signal per se.

In describing exemplary embodiments, specific terminology is used for the sake of clarity. For purposes of description, each specific term is intended to at least include all technical and functional equivalents that operate in a similar manner to accomplish a similar purpose. Additionally, in some instances where a particular exemplary embodiment includes a plurality of system elements, device components or method steps, those elements, components or steps may be replaced with a single element, component or step. Likewise, a single element, component or step may be replaced with a plurality of elements, components or steps that serve the same purpose. Moreover, while exemplary embodiments have been shown and described with references to particular embodiments thereof, those of ordinary skill in the art will understand that various substitutions and alterations in form and detail may be made therein without departing from the scope of the invention. Further still, other embodiments, functions and advantages are also within the scope of the invention.

1. A computer-implemented method for managing promotional item inventory, comprising:
receiving, by a processor, a credential associated with a user;
receiving, by the processor, a reason for use of an inventoried promotional item based on a selection of the reason by the user in a user interface;
receiving, by the processor, an account type based on a selection of the account type by the user in the user interface;
sending, by the processor, the user credential, the reason for use, and the account type to a server;
receiving, by the processor, an inventoried promotional item recommendation from the server;
outputting, by the processor, the inventoried promotional item recommendation for display to the user in the user interface;
receiving, by the processor, a response to the inventoried promotional item recommendation based on a selection of the response by the user in the user interface; and
granting, by the processor, to the user, an access privilege to the promotional item inventory based on the received response.

2. The method of claim 1, wherein receiving the credential associated with the user comprises receiving information of an identification card from an access control module, wherein the access control module comprises one of a magnetic stripe card reader, a contactless card reader, or a chip card reader.

3. The method of claim 1, wherein receiving the credential associated with the user comprises receiving a fingerprint from an access control module.

4. The method of claim 1, wherein the reason for use comprises one of promotional event, account opening, customer request, or complaint handling.

5. The method of claim 1, wherein the account type comprises one of checking account, saving account, credit card account, money market account, certificate of deposit account, automobile loan account, or mortgage account.

6. The method of claim 1, further comprising:
determining an inventoried promotional item count;
updating the inventoried promotional item count; and
sending the updated inventoried promotional item count to the server.

7. The method of claim 6, wherein determining the inventoried promotional item count comprises:
detecting, by a weight sensing module, a total inventoried promotional item weight, and
calculating the inventoried promotional item count based on the total inventoried promotional item weight and a unit weight.

8. A computer-implemented method for generating a promotional item recommendation, comprising:
receiving, by a server, a credential associated with a user from a user device;
retrieving, by the server, an activity log of prior promotional item use associated with the user based on the received user credential;
receiving, by the server, a reason for use of an inventoried promotional item based on a selection of the reason by the user in a user interface and an account type based on a selection of the account type by the user in the user interface;
retrieving, by the server, return on investment (ROI) data associated with one or more inventoried promotional items;
checking, by the server, availability of the one or more inventoried promotional items;
generating, by the server, an inventoried promotional item recommendation based on the activity log, the reason for use, the account type, the ROI data, and the availability of the one or more inventoried promotional items;
outputting, by the server, the inventoried promotional item recommendation to the user device;
receiving, by the server, a response to the inventoried promotional item recommendation based on a selection of the response by the user in the user interface; and
granting, by the server, to the user, an access privilege to a promotional item inventory based on the received response.

9. The method of claim 8, wherein the credential associated with the user comprises information of an identification card, a personal identification number, biometric information of the user, or a combination thereof.

10. The method of claim 8, wherein the activity log comprises one or more item names and one or more quantities associated with the one or more item names.

11. The method of claim 8, wherein the reason for use comprises one of promotional event, account opening, customer request, or complaint handling.

12. The method of claim 8, wherein the account type comprises one of checking account, saving account, credit card account, money market account, certificate of deposit account, automobile loan account, or mortgage account.

13. The method of claim 8, further comprising:
receiving, by the server, for each of the one or more inventoried promotional items, information selected from the group consisting of popularity per time of day, popularity per day of week, popularity per quarter of year, popularity per season, popularity per geographic location, popularity per weather condition, and a combination thereof, wherein popularity comprises rate of distribution; and
generating, by the server, the inventoried promotional item recommendation based on the received information.

14. A system of promotional item inventory management, comprising:
a memory;
a scanner configured to read a UPC barcode or QR code;
a weight sensing module configured to detect a total item weight; and
a processor in communication with the scanner and the weight sensing module and configured to execute program instructions causing the processor to:
receive the UPC barcode or QR code from the scanner;
retrieve an item name associated with the UPC barcode or QR code from the memory;
receive the total item weight from the weight sensing module;
retrieve a unit item weight associated with the item name from the memory;
determine an item count based on the total item weight and the unit item weight; and
output the item name and the item count to a server.

15. The system of claim 14, comprising an access control module, wherein the access control module comprises one of a magnetic stripe card reader, a contactless card reader, or a chip card reader.

16. The system of claim 14, wherein the program instructions further cause the processor to:
compare the item count to a threshold value;
generate an order in response to the item count being less than the threshold value; and
output the order to a pre-determined entity.

17. The system of claim 14, wherein the program instructions further cause the processor to:
receive a user credential from a user;
receive a reason for use from the user;
receive an account type from the user;
send the user credential, the reason for use, and the account type to a server;
receive an item recommendation from the server;
output the item recommendation to the user;
receive a response to the item recommendation from the user; and
grant the user an access privilege based on the received response.

18. The system of claim 17, wherein the activity log associated with the user comprises a date, an item name, and a quantity associated with the item name.

19. The system of claim 17, wherein the reason for use comprises one of promotional event, account opening, customer request, or complaint handling.

20. The system of claim 17, wherein the account type comprises one of checking account, saving account, credit card account, money market account, certificate of deposit account, automobile loan account, or mortgage account.
